(19) United States
(12) Patent Application Publication
(10) Pub. No.: US 2010/0114517 A1
(43) Pub. Date: May 6, 2010

(54) METHOD AND SYSTEM FOR ORIENTATION SENSING

(75) Inventors: Hans Marc Bert Boeve, Hechtel-Eksel (BE); Teunis Jan Ikkink, Geldrop (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/594,223

(22) PCT Filed: Mar. 27, 2008
(86) PCT No.: PCT/IB08/51139

§ 371 Date: Oct. 1, 2009

(30) Foreign Application Priority Data
Apr. 2, 2007 (EP) 07105453.0

(51) Int. Cl. G01C 17/38; G01C 21/08; G06F 19/00

(52) U.S. Cl. 702/92; 702/153

(57) ABSTRACT

An orientation sensing system uses an algorithm that iteratively improves an estimate of the body attitude. In each iteration, an error vector is generated that represents the difference between the actually measured sensor signals on the one hand, and a model-based prediction of these sensor signals, given the attitude estimate of the previous iteration, on the other hand. From the compound sensor data error vector, an attitude estimation error (a 3 degrees-of-freedom rotation) is calculated by multiplying the compound error vector by the pseudo-inverse of a sensitivity matrix. An improved attitude estimate is then obtained by applying the inverse of the attitude estimation error to the old attitude estimate.

### FIELD OF THE INVENTION

The invention relates to a data processing system, comprising a sensor arrangement operative to sense first and second vector fields at a location of the sensor arrangement, and data processing means for determining an attitude of the sensor arrangement with respect to the first and second vector fields sensed.

The invention further relates to a method of determining an attitude of a sensor arrangement with respect to first and second vector fields sensed at a location of the sensor arrangement by the sensor arrangement.

The invention further relates to software for implementing the method when running on a data processing means.

### BACKGROUND ART

WO2006/117731 of the same inventors relates to a device comprising sensor arrangements for providing first field information defining at least parts of first fields and for providing second field information defining first parts of second fields. The device is provided with an estimator for estimating second parts of the second fields as functions of mixtures of the first and second field information, so as to become more reliable and user friendly. The fields may be earth gravitational fields and/or earth magnetic fields and/or further fields. The mixtures comprise dot products of the first and second fields and/or first products of first components of the first and second fields in first directions and/or second products of second components of the first and second fields in second directions. The second parts of the second field comprise third components of the second field in third directions. The estimator can further estimate third components of the first field in third directions as further functions of the first field information. More specifically, WO2006/117731 discloses a method to reconstruct three-dimensional (3D) vector fields U and V from measurements of the fields by either two two-dimensional (2D) sensors, or by a 2D sensor and a 3D sensor. In a preferred embodiment the fields U and V may be the earth's gravity field and the earth's magnetic field, respectively. From the reconstructed fields U and V, the 3×3 attitude matrix ^{r}C of the orientation sensor can be determined by relating the a-priori known reference-frame representation of the fields (^{r}U and ^{r}V) to the reconstructed body-frame representation of the fields (^{c}U and ^{c}V). See formula 302 in FIG. 3. The superscript “^{c}”, as in ^{c}U and ^{c}V, indicates that the quantity is expressed with respect to the body (corpus) coordinate system.

D. Gebre-Egziabher et al., “A Gyro-Free Quaternion-Based Attitude Determination System Suitable for Implementation Using Low Cost Sensors”, IEEE Position Location and Navigation Symposium, San Diego, Calif., USA, March 2000, describes another iterative attitude estimation method.

### SUMMARY OF THE INVENTION

The invention uses an algorithm that iteratively improves an estimate of the body attitude. In each iteration, an error vector is generated that represents the difference between the actually measured sensor signals (the observations) on the one hand, and a model-based prediction of these sensor signals, given the attitude estimate of the previous iteration, on the other hand. From the compound sensor data error vector an attitude estimation error (a 3 degrees-of-freedom rotation) is calculated by multiplying the compound error vector by the pseudo-inverse of a Sensitivity matrix. A new (improved) attitude estimate is then obtained by applying the inverse of the attitude estimation error to the old attitude estimate. To improve convergence, a provision (line search) may be included that scales down the attitude estimation error before it is applied to the old attitude estimate.

Similar schemes, such as that of D. Gebre-Egziabher et al, referred to above, differ from the invention in that the error signal generated is not a difference of measured and predicted sensor data vectors, but rather a difference of measurement-inferred and predicted vector fields U and V. In the case of 3D sensors, the measurement-inferred vector fields can be obtained, by inverting the sensor model matrix equation. However, if one or more sensor axes are missing, the corresponding sensor model matrix equation cannot be inverted and the corresponding field can only be estimated, e.g., by applying a-priori knowledge about the vector fields. Hence the “measurement-inferred” vector field would not be inferred exclusively from the measurement, but would also depend, like the predicted vector field, on the a-priori knowledge about the field. Such an approach would make the difference between the “measurement-inferred” vector field and the predicted vector field less meaningful as an error signal, and would eventually result in inaccurate attitude estimates. For this reason, it is preferred that the error signal be representative of the difference between the actually measured sensor data vector and a predicted data vector. This brings along the added benefit that one may easily apply different weighting coefficients to the components of the sensor data error vector, depending on the reliability of the corresponding physical sensor (axis). Thus it becomes easier to deal with sensors having different reliability levels (e.g., the z-axis of a monolithic 3D accelerometer usually has poorer performance owing to, e.g., offset drift and noise, than the x- and y-axes). A smaller weighting coefficient can be assigned to the component of the sensor data error vector that corresponds to the accelerometer z-axis.

The present invention thus uses a model-based iterative method to improve the accuracy of the attitude determination as well as the body-fixed vector representations ^{c}U and ^{c}V estimated from it. The method preferably relies on the method disclosed in WO2006/117731 for obtaining a good initial attitude estimate. In other words, the iterative method estimates body attitude from the signals observed in body-fixed sensors that are responsive to two different physical vector fields. The representations of the two vector fields in the reference coordinate system are applied as a-priori knowledge. Unlike other known iterative body attitude estimation schemes, the invention can also be used if one of the two sensors is a 2D sensor instead of a 3D sensor, or if both sensors are 2D instead of 3D (to yield simpler technology, lower-cost). The invention achieves a significant accuracy improvement over the vector reconstruction method, described in WO2006/117731. The iterative attitude estimation method described in the publication by D. Gebre-Egziabher et al., referred to above, is not applicable to sensor configurations having fewer than six (three for U, three for V) axes.

The approach in accordance with the invention also makes it easier to deal optimally with sensor configurations, wherein the sensors (or sensor axes) have different inaccuracies (e.g. different noise levels, offsets, or non-linearities).

More specifically, the invention relates to a data processing system that comprises a sensor arrangement operative to sense first and second vector fields at a location of the sensor arrangement, and data processing means for determining an attitude of the sensor arrangement with respect to the first and second vector fields sensed. The data processing means is configured to determine respective estimates of the attitude in respective iterations. In a first iteration the data processing means is operative to receive from the sensor arrangement first data representative of the first vector field sensed, and second data representative of the second vector field sensed, and to receive an initializing estimate of the attitude. The initializing estimate can be provided, e.g., using the approach of WO2006/117731. For each next one of the iterations the data processing means is operative to determine the next estimate of the attitude by carrying out following steps: determining a next first prediction of the first data and a next second prediction of the second data based on the previous attitude estimate determined in the previous iteration; generating a first quantity representative of a first difference between the first data and the next first prediction; generating a second quantity representative of a second difference between the second data and the next second prediction; determining a next attitude estimation error based on the first and second quantities; and determining a further quantity representative of the next estimate by modifying the previous estimate based on the next attitude estimation error.

The orientation sensing system of the invention uses an algorithm that iteratively improves an estimate of the body attitude. In each iteration, an error vector is generated that represents the difference between the actually measured sensor signals on the one hand, and a model-based prediction of these sensor signals, given the attitude estimate of the previous iteration, on the other hand. From the compound sensor data error vector, an attitude estimation error (e.g., a 3 degrees-of-freedom rotation) is calculated by multiplying the compound error vector by the pseudo-inverse of a sensitivity matrix. An improved attitude estimate is then obtained by applying the inverse of the attitude estimation error to the old attitude estimate.

The iterative process stops when a predetermined criterion has been met. For example, the iterative process stops if the magnitude of the first quantity has become smaller than a predetermined first threshold and the magnitude of the second quantity has become smaller than a predetermined second threshold. As another example, the iterative process stops if the magnitude of the next attitude estimation error has become smaller than a predetermined threshold.

As mentioned above, the invention provides a significant improvement in accuracy with regard to the approach of WO2006/117731, and is more universal than the approach in D. Gebre-Egziabher et al., as it is applicable to any combination of 2D and 3D sensors, e.g., a 3D magnetometer and a 2D accelerometer.

The data processor means can be implemented by dedicated hardware, a dedicated data processor, a general-purpose data processor using dedicated software, a data processing system with distributed functionalities such as a data processing network, etc.

In an embodiment of the invention, the data processing means is operative to normalize the further quantity so as to have the further quantity represent a pure rotation. The normalization is carried out to ensure that the new estimate is indeed a pure rotation. Examples are discussed in detail further below.

In a further embodiment, the data processing means is operative to determine another quantity representative of the next attitude estimate by modifying the previous attitude estimate using a scaled-down version of the next attitude estimation error. The down-scaling is applied to ensure that the magnitude of the compound sensor data error vector decreases indeed in each iteration (in other words: to ensure convergence). A criterion for determining the factor, by which to scale down the attitude estimation error in the current iteration, is whether it would yield a sufficient decrease of length of the compound sensor data error vector for the next iteration. Details are discussed further below.

In an embodiment of the invention, the system is accommodated in a mobile device, e.g., an electronic compass, a mobile telephone, a palmtop computer, etc. Alternatively, the sensor arrangement is accommodated in a mobile device, and the device has an interface for communicating via a data network with a server accommodating the data processing means. This distributed system approach enables multiple users to receive a service that can be maintained and upgraded centrally.

In a further embodiment, the first vector field is the earth's magnetic field, and the second vector field is the earth's gravity field. The sensor arrangement comprises, e.g., a 3D or 2D magnetometer, and a 3D or 2D accelerometer.

The invention further relates to a method of determining an attitude of a sensor arrangement with respect to first and second vector fields sensed by the sensor arrangement at a location of the sensor arrangement. The method comprises determining respective attitude estimates in respective iterations. The method comprises in a first iteration receiving from the sensor arrangement first data representative of the first vector field sensed, and second data representative of the second vector field sensed, and receiving an initializing attitude estimate. For each next one of the iterations the method comprises determining a next attitude estimate by carrying out following steps: determining a next first prediction of the first data and a next second prediction of the second data based on the previous attitude estimate determined in the previous iteration; generating a first quantity representative of a first difference between the first data and the next first prediction; generating a second quantity representative of a second difference between the second data and the next second prediction; determining a next attitude estimation error based on the first and second quantities; and determining a further quantity representative of the next attitude estimate by modifying the previous estimate based on the next attitude estimation error.

A method according to the invention can be commercially exploited by, e.g., a service provider who receives the sensor data via a data network and returns the final attitude estimate in operational use of a mobile sensor arrangement, e.g., as integrated within a mobile telephone.

The invention further relates to software for configuring data processing means for use in a system according to the invention. This software can be commercially exploited by a software provider, who supplies this dedicated software to users of mobile appliances that are equipped with a sensor arrangement, or that can be equipped with a sensor arrangement as an after-market add-on.

### BRIEF DESCRIPTION OF THE DRAWING

The invention is explained in further detail, by way of example and with reference to the accompanying drawing, wherein:

FIGS. 1 and 2 are block diagrams for a system in the invention;

FIGS. 3 to 8 list mathematical expressions clarifying the various operations; and

FIG. 9 is a block diagram of an embodiment of a system in the invention.

Throughout the drawing, similar or corresponding features are indicated by same reference numerals.

### DESCRIPTION OF EMBODIMENTS

### Block Diagrams

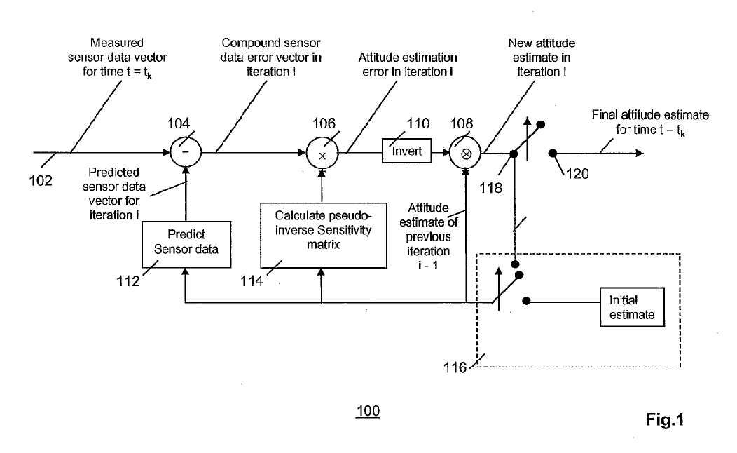

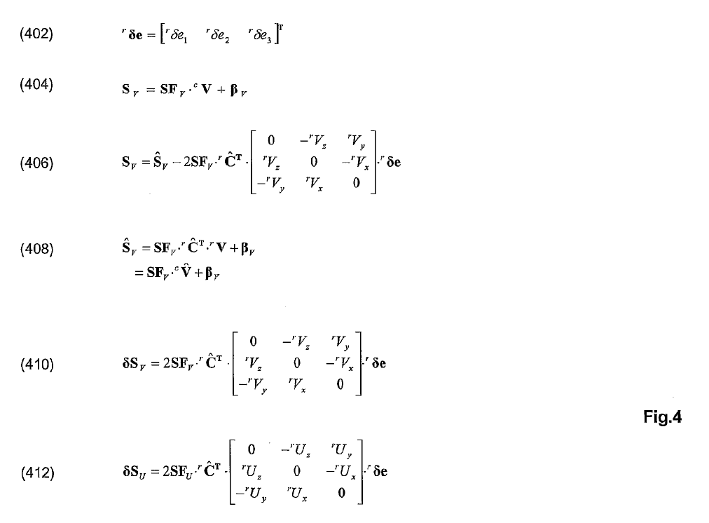

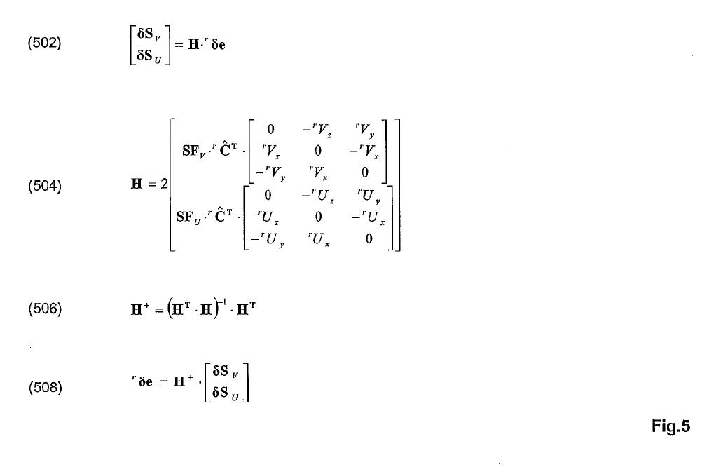

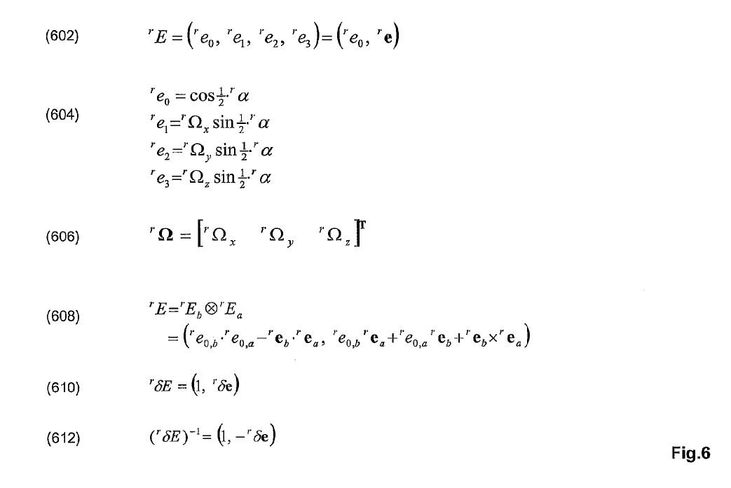

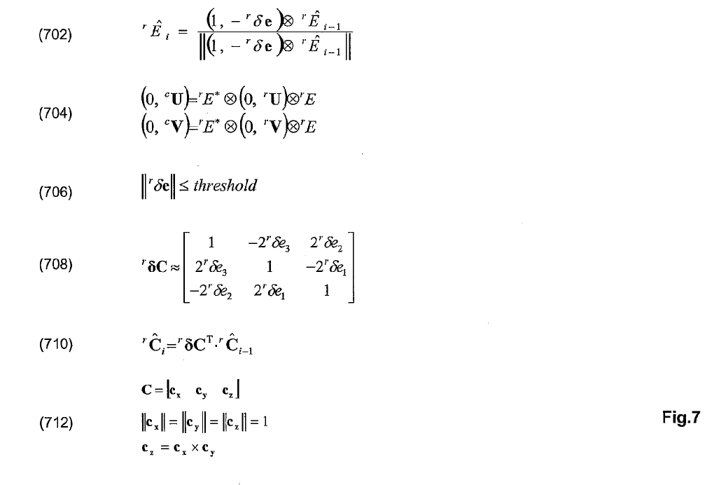

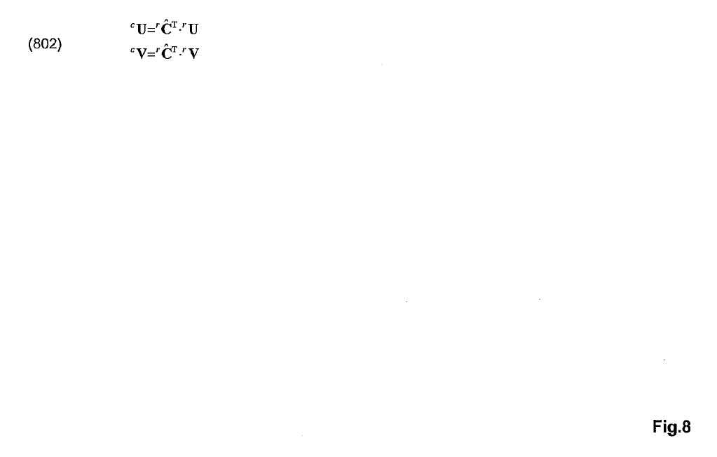

FIG. 1 is a block diagram of relevant functionalities of a system 100 in the invention. System 100 comprises an input 102 for receiving from a vector field sensor arrangement (not shown) the data representative of the vector field sensed at a time t=tₖ. System 100 further has a combiner 104, a matrix multiplier 106, an inverter 110 for inverting the output of multiplier 106, a quaternion multiplier unit 108 (for quaternion representations, see further below), a unit 112 for performing a next prediction of the data vector from the sensor, and a unit 114 for calculating the pseudo-inverse of the sensitivity matrix H discussed further below, and given by expression (504) in FIG. 5. System 100 further comprises an initialization section 116 that inputs an initial attitude estimate, e.g., as produced according to the approach discussed in WO2006/117731, referred to above. The initial attitude estimate is being used in the first iteration i=1 for producing the second attitude estimate. Section 116 then routes all next attitude estimations, from the second attitude estimate onwards, to quaternion multiplier 108, and to unit 112 and unit 114. Operation of system 100 is as follows. Combiner 104 forms an output by determining a difference between, on the one hand, the data vector representative of the actual signals measured by the sensor at instant time t=tₖ and, on the other hand, the data vector representative of the predicted signals from the sensor for the i-th iteration. Unit 112 supplies the predicted sensor data vector based on the attitude estimate calculated in a previous iteration, and available at node 118. Combiner 104 thus forms a compound error vector that is supplied to multiplier 106. Expressions (410) and (412) in FIG. 4 relate to the sensor data error vectors for vector fields V and U, respectively, and are discussed further below. Multiplier 106 subjects the compound error vector to a matrix multiplication with the pseudo-inverse of the sensitivity matrix as given by expression (506) in FIG. 5 discussed below, producing the attitude estimation error for the i-th iteration as given by expression (508) in FIG. 5. Unit 108 determines a next (improved) attitude estimate by applying the inverse of the attitude estimation error, produced by inverter 110 to the previous attitude estimate. This last operation is discussed in further detail below with reference to expression (612) in FIG. 6, and expression (702) in FIG. 7. The iterations continue for the current measured sensor data vector until a stop criterion has been met. The attitude estimate for time t=tₖ, then available at node 118, is supplied to an output node 120.

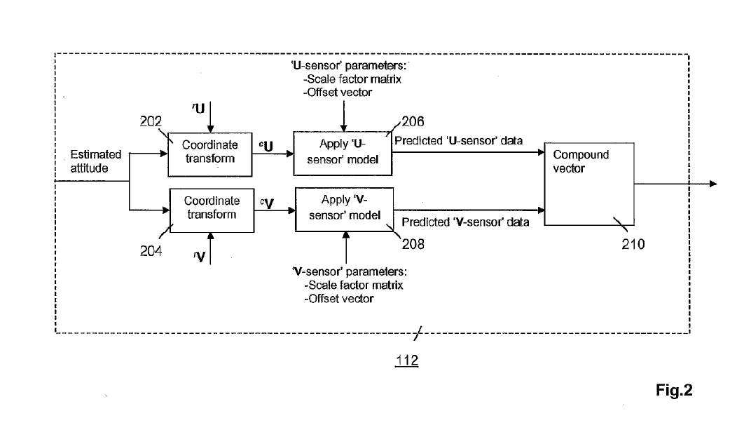

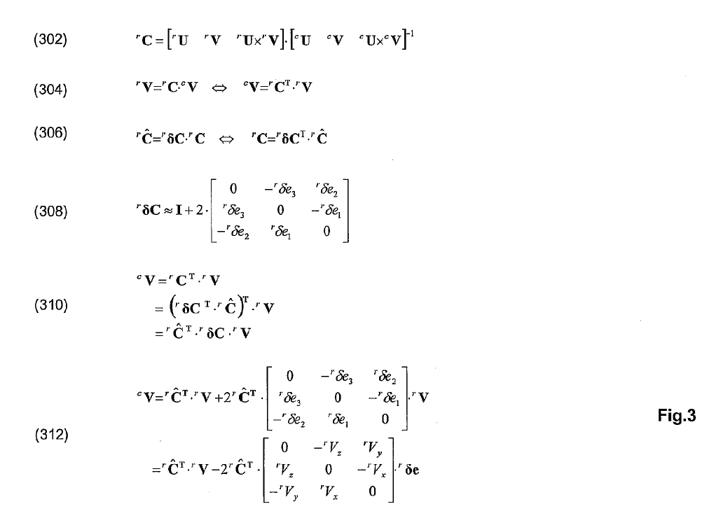

FIG. 2 is a block diagram of unit 112 operative to predict the next sensor data vector. The sensor data vectors for the U and V vector fields are predicted by calculating, in units 202 and 204 the body-fixed vector field representations ^{c}U and ^{c}V, based on the estimated attitude ^{r}C supplied at node 118 and the known reference-frame field representations ^{r}U and ^{r}V, and then feeding the body-fixed vectors ^{c}U and ^{c}V into their corresponding sensor models in units 206 and 208. Units 206 and 208 have their outputs supplying their respective data to a unit 210 that provides the predicted vector being the predicted sensor data vector for the U and V sensor channels combined. Accordingly, unit 112 uses the known representation of the U and V fields in the reference coordinate frame to calculate the corresponding body-fixed representation. The body-fixed field representations are then applied to the models of the corresponding sensors to yield the predicted sensor data vectors. This step requires the parameters of the sensor models to be known. In the usual case of a linear sensor model, these parameters comprise a sensor offset vector and a sensor scale factor matrix (giving a total of four coefficients per sensor axis).

As can be seen from expression (302), discussed in WO2006/117731 mentioned above, the relation between ^{c}U and ^{c}V on the one hand and the body attitude matrix ^{r}C on the other hand is non-linear. Hence the relation between sensor data vectors and attitude is non-linear as well. The same holds for the corresponding error signals. In order to be able to calculate an attitude estimation error from the sensor data error vector, the non-linear relation is linearized in the vicinity of the estimated attitude of the previous iteration (“operating point”). This is done by calculating a sensitivity matrix whose coefficients represent the sensitivities of the sensor data error vector components to the components of the attitude estimation error. Since there are more components in the sensor data error vector (5 in the case of a 2D sensor for one field and a 3D sensor for the other field) than there are in the attitude estimation error (three), the sensitivity matrix cannot be inverted, but instead a pseudo-inverse must be taken, which yields a root-mean-square (rms) best fit of the attitude estimation error to the sensor data error vector.

### Derivation Sensitivity Matrix and Pseudo-Inverse

The relation between quantities in the known reference-frame (superscript ^{r}) and the true body-frame (superscript ^{c}) representations of a vector V is given by expression (304). The columns of the 3×3 attitude matrix ^{r}C are the base vectors of the body-coordinate system, expressed in the reference frame coordinates. The aim of each iteration in the attitude estimation procedure is to find an estimate ^{r}Ĉ of the true (but unknown) attitude ^{r}C. The estimated attitude and the true attitude are related by the attitude estimation error ^{r}δC given by expression (306). All three matrices in expression (306) have a 3×3 dimension and indicate rotations. The interpretation of expression (306) is as follows: in order to find the estimated attitude, rotate the true attitude by the attitude estimation error. If the attitude estimation error ^{r}δC is to represent a small pure rotation, there can only be three degrees-of-freedom in its coefficients; and the matrix can be approximated by expression (308). The matrix I in expression (308) is the 3×3 identity matrix, and the three coefficients ^{r}δe₁, ^{r}δe₂, ^{r}δe₃ represent half-angles of rotation about the x-, y- and z-axes of the reference coordinate frame. Substituting expression (306) into expression (304) yields expression (310). Substituting expression (308) for the attitude estimation error into expression (310) and reworking the result gives expression (312). In expression (312) the 3D vector quantity ^{r}δe is as defined in expression (402). The first term on the right-hand side of expression (312) can be interpreted as the predicted body-referenced vector ^{c}\hat{V}=^{r}Ĉ^{T}·^{r}V, and the second term is the prediction error. As a next step the linear sensor model is considered as given by expression (404), wherein S_{V} is the sensor data vector, SF_{V} is the scale factor matrix and β_{V} is the offset vector. Substituting expression (312) into expression (404) gives expression (406), wherein the sensor data vector estimate Ŝ_{V} is defined according to expression (408). The sensor data error vector δS_{V}=Ŝ_{V}−S_{V} can now be related to the vector ^{r}δe, which represents the attitude estimation error, as given by expression (410). This is the desired linear relation between sensor data error vector and attitude estimation error for one of the two vector fields, vector field V. For the other field U the same derivation process applies and results in expression (412).

Both matrix equations (410) and (412) can be combined in a single matrix equation according to expression (502), wherein the sensitivity matrix H is given by expression (504). If both U and V field are measured by a 3D sensor, the sensitivity matrix H has dimension 6×3. If one of the fields is measured by a 2D sensor, the dimension of H reduces to 5×3. The compound (6×1 or 5×1) sensor data error vector over-specifies the (3×1) attitude estimation error. Hence, to calculate the attitude estimation error from the sensor data error vector, matrix equation (502) cannot be inverted. However, it is possible to calculate a best fit (e.g., in the root-mean-square sense) of the attitude error, by calculating the pseudo-inverse H⁺ of H given by expression (506). The pseudo-inverse has the property that H⁺·H=I, where I is an identity matrix with row and column dimension equal to the column dimension of H (in this case the dimension equals 3). The attitude estimation error is now determined from the compound sensor data error vector as given by expression (508).

As an aside, the sensor data error vectors have been defined as a difference between the predicted sensor data vector and the sensor data vector that would be obtained for the true attitude. The latter quantity is not available in a practical system, and instead the measured sensor data vector is used. Although the measured sensor data vector is related to the true attitude, it is also hampered by noise and by the effects of other sensor non-idealities. Hence, even after many iterations, the estimated attitude can only be expected to approach the true attitude.

### Implementations

The three degrees-of-freedom attitude C can be represented in a number of fundamentally different ways (apart from a large number of different conventions), for example:
1) Euler angles, for example pitch, roll, and yaw. The Euler angles representation is a set of three angles which represent successive rotations about three given rotation axes.
2) Axis & angle. Here body attitude is considered to be the result of a single rotation through a specified angle, about a specified axis.
3) Quaternion representation uses quaternions. A quaternion is a 4-dimensional hypercomplex number. Within the context of rotations, the four quaternion components are also called Euler parameters (not to be confused with Euler angles). Ordinary complex numbers consist of two real numbers, and can be used to describe one-degree-of freedom rotations in a 2D plane. Likewise, the four real Euler parameters that constitute a quaternion, can be used to describe three-degrees-of-freedom rotations in a 3D space.
4) Rotation matrix, also called direction-cosine matrix, is a 3×3 matrix whose columns give the base vectors of the body coordinate frame expressed in terms of the reference coordinate frame. It uses nine coefficients to represent just three degrees of freedom

Preferably, the quaternion representation or the rotation matrix representation is used, because they allow easy calculation of the attitude resulting from a succession of rotations (as is done due to the iterative character of the algorithm. Below, first the quaternion representation is discussed, and then the rotation matrix representation.

### Quaternion Representation

A quaternion and its four Euler parameters are often denoted by an expression (602). The interpretation of the Euler angles follows from expressions (604). Herein, the unit length vector Ω whose components are given by expression (606) is the rotation axis, and the angle ^{r}α is the rotation angle. A quaternion represents a rotation if its length (the rms sum of its four components) equals unity. The attitude resulting from two successive rotations (first rotation a, then rotation b) can be described as a product of the corresponding quaternions according to expression (608). The symbol [symbol] denotes the quaternion product operator. The expression for the quaternion product is needed when calculating the new attitude estimate from the previous attitude estimate and the attitude estimation error.

Inspection of expression (604) reveals that the quaternion of a small rotation (e.g., the attitude estimation error) can be approximated by an expression (610), wherein ∥^{r}δe∥<<1. Expression (612) gives the inverse, i.e., the small rotation in the other direction, relevant to the operation of unit 110. Note that the three components of the vector ^{r}δe can be directly mapped onto the components of the attitude estimation error, as given by expression (508). The calculation of the new attitude estimate can now be performed in accordance with expression (702), wherein the subscript “i” refers to the i^{th} iteration step, and the subscript “i-1” refers to the preceding iteration step. The normalization is to maintain a unity-length quaternion (i.e., a pure rotation). This is needed for two reasons. A first reason is that the approximation according to expression (610) gives a small increase of the quaternion length in each iteration step. A second reason is that round-off errors build up over many iterations. The advantage of using the quaternion representation for the attitude is the simple way wherein a pure rotation can be maintained (by normalizing the length of the quaternion).

From the new attitude estimate, the vectors ^{c}U and ^{c}V can be predicted in units 202 and 204 of FIG. 2. In quaternion algebra, vector rotation can be written as a quaternion triple product (704), wherein the vectors ^{c}U and ^{c}V are augmented by a zero in the first position to make them amenable to the quaternion product operator.

The iterative algorithm needs a criterion in order to determine when convergence has been achieved so as to stop iterating. For the vector matching algorithm, a possible stop criterion is given by expression (706), wherein the threshold is chosen, e.g., as a fraction of the attitude accuracy that is desired.

As an alternative one may also examine the length of the compound sensor data error vector. When this length has become less than a fraction of the (known) rms noise level in the sensors, there is no benefit in trying to obtain a better estimate.

### Rotation Matrix Representation

An alternative to the quaternion representation, discussed above, is the more familiar matrix representation of attitude. The rotation matrix ^{r}δC corresponding to the attitude estimation error of expression (610) is given by expression (708). In principle, the update equation for the new attitude estimate in terms of the previous attitude estimate and the attitude estimation error is given by expression (710). However, because expression (708) gives only an approximation of a small rotation, an additional measure must be taken to ensure that the matrix representing the new attitude estimate is indeed a pure rotation matrix.

A 3×3 matrix C with column vectors cₓ, c_{y} and c_{z} represents a pure rotation if, and only if, it complies with the following requirements: the length of each of its column vectors is unity; and the column vectors are mutually orthogonal. These requirements are represented by expressions (712). Expressions (712) represent six constraints (scalar equations) imposed on matrix C, leaving only the three degrees of freedom for the attitude in the nine coefficients of the matrix. There are various ways in which a general matrix C can be modified to comply with equations (712). The following strategy is given by way of example. Replace the first column vector of matrix C with its normalized version by scaling the length of vector cₓ to unity. Replace the third column vector with the normalized cross-product of the original first and second column vectors cₓ and c_{y}. Use as the new second column vector the cross-product of the new third and first column vectors. It may be clear that one can think of numerous variants of the above recipe (which are not mutually equivalent). This recipe can be applied to the result of expression (710) to ensure that the outcome does indeed represent a pure rotation.

The vectors ^{c}U and ^{c}V can now be predicted (see the operations in the block diagram of FIG. 2) from the attitude estimate according to expression (802), after which they can be fed through the sensor model units 206 and 208 to predict a new compound sensor data vector for the next iteration.

### Convergence Improvement

The attitude estimation error above was derived under the assumption that it was a small error. However, depending on the quality of the initial attitude estimate, especially in the first few iterations, the calculated attitude estimation error may be a severe over-estimate of the true error in the attitude estimate. This may result in the need for an excessive number of iterations and/or even failure to converge. If one or more sensor axes are missing, there are certain attitudes for which the signals of all the remaining sensor axes are insensitive to subsequent small attitude changes. In such a situation, the attitude estimation error can be a gross over-estimate of the truly required attitude step and again poor convergence may be the result.

Because it is based on a derivative (the sensitivity matrix), the calculated attitude estimation error always gives the correct direction towards an improvement of the attitude estimate. However, because the underlying relation between attitude and predicted vectors is non-linear, the length of the estimation error may be an over-estimate. Thus a method is needed to scale down the length of the attitude estimation error, while keeping the direction the same, before applying it to determine the new attitude estimate. This downscaling corresponds to decreasing the angle of the rotation that must be applied in the current iteration, while keeping the associated rotation axis the same. The downscaling bears similarities to a line-search approach that is often applied in multidimensional Newton-Raphson root-finding to decrease the (multidimensional) iteration step size. In Newton-Raphson root-finding however, the step is additive to the result of the previous iteration, whereas in the present vector-matching algorithm the estimation error is applied in a multiplicative way, see expression (702).

To decide whether the rotation step is small enough, the corresponding new attitude is calculated as well as the corresponding compound sensor data error vector. If the length of the sensor data error vector has increased instead of decreased with respect to that found in the previous iteration, the rotation step is too large. Then, a smaller step is tried. If the length of the sensor data error vector has decreased with respect to that in the previous iteration, the step is accepted. Note that with the line-search approach incorporated, the actions of calculating a new attitude and the corresponding compound sensor data error vector may have to be performed multiple times in each iteration in order to obtain an acceptable step. The frequency with which the more intensive calculation of the sensitivity matrix and its pseudo-inverse is performed however remains once per iteration. For more details on how to determine the factor by which the step is to be reduced for the next iteration, see, e.g., Numerical Recipes in C, 2^{nd} ed., W.H. Press et al., Cambridge University Press, 1992, section 9.7.

### Single Device or Distributed System Implementations

System 100 as discussed above can be implemented in a variety of manners. In a first implementation, system 100 is accommodated in a single device, e.g., a mobile device such as an electronic compass. The electronic compass can be an independent entity or can itself be integrated in a mobile telephone or a palmtop computer, etc.

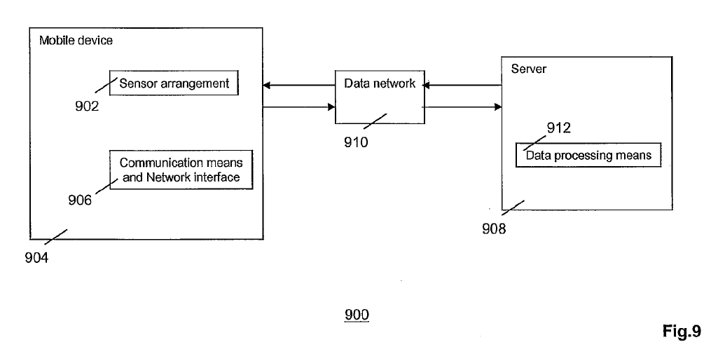

FIG. 9 illustrates a second embodiment 900 of system 100. A sensor arrangement 902 supplying the measured sensor data vector at input 102 is accommodated in a single physical device 904, e.g., a mobile device, that also has data communication means and a network interface 906 for (wireless) communication with a server 908 via a data network 910, such as the

Internet. Server 908 has data processing means 912 for carrying out the processing of the data received from sensor arrangement 902 as representative of the sensed vector fields, e.g., the earth's magnetic field and the earth's gravity field, in order to determine the attitude of arrangement 902, and therefore of device 904, relative to these vector fields. The data processing has been discussed in detail above. An advantage of the configuration of embodiment 900 is that the processing is delegated to a server. As a result, compute power is not required of device 904, and server 908 can be maintained and updated centrally so as to optimize the processing and the providing of the service to the user of device 904. For example, the user could have sensor arrangement 902 installed at his/her mobile telephone 904 as an after-market add-on, whereupon the service provided by server 908 becomes accessible, thus allowing various commercially interesting business models based on navigational aids.

In a third embodiment, system 100 is accommodated in a single physical device, wherein the processing means, for carrying out the processing of the data received from sensor arrangement 902 as representative of the sensed vector fields, as discussed with reference to the previous Figs., is implemented in software running on a general purpose data processor onboard the device. Again, sensor arrangement 902 could be installed as an aftermarket add-on, and the software could be downloaded onto the device to enable the system in the invention.

Accordingly, an orientation sensing system in the invention uses an algorithm that iteratively improves an estimate of the body attitude. In each iteration, an error vector is generated that represents the difference between the actually measured sensor signals on the one hand, and a model-based prediction of these sensor signals, given the attitude estimate of the previous iteration, on the other hand. From the compound sensor data error vector, an attitude estimation error (a 3 degrees-of-freedom rotation) is calculated by multiplying the compound error vector by the pseudo-inverse of a sensitivity matrix. An improved attitude estimate is then obtained by applying the inverse of the attitude estimation error to the old attitude estimate.

1. A data processing system, comprising:
a sensor arrangement operative to sense first and second vector fields at a location of the sensor arrangement, wherein the first vector field is the earth's magnetic field, and the second vector field is the earth's gravity field;
data processing means for determining an attitude of the sensor arrangement with respect to the first and second vector fields sensed; wherein:
the data processing means is configured to determine respective estimates of the attitude in respective iterations;
in a first iteration the data processing means is operative to receive from the sensor arrangement first data representative of the first vector field sensed, and second data representative of the second vector field sensed, and to receive an initializing estimate of the attitude;
for each next one of the iterations the data processing means is operative to determine the next estimate of the attitude by carrying out following steps:
determining a next first prediction of the first data and a next second prediction of the second data based on the previous attitude estimate determined in the previous iteration;
generating a first quantity representative of a first difference between the first data and the next first prediction;
generating a second quantity representative of a second difference between the second data and the next second prediction;
determining a next attitude estimation error based on the first and second quantities; and
determining a further quantity representative of the next estimate by modifying the previous estimate based on the next attitude estimation error, and
the data processing means is configured to end the iterative process when a predetermined criterion has been met.

2. The system of claim 1, wherein the data processing means is operative to normalize the further quantity so as to have the further quantity represent a pure rotation.

3. The system of claim 1, wherein the data processing means is operative to determine another quantity representative of the next attitude estimate by modifying the previous attitude estimate using a scaled-down version of the next attitude estimation error.

4. The system of claim 1, accommodated in a mobile device.

5. The system of claim 1, wherein:
the sensor arrangement is accommodated in a mobile device;
the device has an interface for communicating with the data processing means via a data network.

6. (canceled)

7. The system of claim 5, wherein the sensor arrangement comprises a 3D magnetometer and a 2D accelerometer.

8. A method of determining an attitude of a sensor arrangement with respect to first and second vector fields sensed by the sensor arrangement at a location of the sensor arrangement, wherein the first vector field is the earth's magnetic field, and the second vector field is the earth's gravity field, and wherein:
the method comprises determining respective attitude estimates in respective iterations;
the method comprises in a first iteration receiving from the sensor arrangement first data representative of the first vector field sensed, and second data representative of the second vector field sensed, and receiving an initializing attitude estimate;
for each next one of the iterations the method comprises determining a next attitude estimate by carrying out following steps:
determining a next first prediction of the first data and a next second prediction of the second data based on the previous attitude estimate determined in the previous iteration;
generating a first quantity representative of a first difference between the first data and the next first prediction;
generating a second quantity representative of a second difference between the second data and the next second prediction;
determining a next attitude estimation error based on the first and second quantities; and
determining a further quantity representative of the next attitude estimate by modifying the previous estimate based on the next attitude estimation error, and
the method further comprises ending the iterative process when a predetermined criterion has been met.

9. The method of claim 8, comprising normalizing the further quantity so as to have the further quantity represent a pure rotation.

10. The method of claim 8, comprising determining another quantity representative of the next attitude estimate by modifying the previous attitude estimate using a scaled-down version of the next attitude estimation error

11. Software for configuring data processing means for use in the system of claim 1.
